(19) United States
(12) Patent Application Publication
(10) Pub. No.: US 2016/0215769 A1
(43) Pub. Date: Jul. 28, 2016

(54) Systems and Methods for Providing Power to Well Equipment

(71) Applicant: Baker Hughes Incorporated, Houston, TX (US)

(72) Inventors: Brian Haapanen, Broken Arrow, OK (US); John M. Leuthen, Claremore, OK (US); Renato L. Pichilingue, Houston, TX (US); Allen A. Moghadas, Austin, TX (US)

(21) Appl. No.: 15/008,047

(22) Filed: Jan. 27, 2016

Related U.S. Application Data
(60) Provisional application No. 62/108,384, filed on Jan. 27, 2015.

(51) Int. Cl. F04B 47/02; H02P 4/00; E21B 43/12

(52) U.S. Cl. CPC F04B 47/02; E21B 43/128; H02P 4/00

(57) ABSTRACT

Systems and methods in which DC power is provided to a common DC bus to which multiple ESP systems are connected. Each ESP system coupled through an interface unit to the common DC bus. The interface unit selectively allows power from the common DC bus to be provided to a drive which then produces AC power without first having to rectify the power received from the common bus. The AC power produced by the drive is provided to the ESP motor, which drives the pump to lift fluid from the well. Each interface unit may include an input contactor that is closed to couple the ESP to the common DC bus, a charging contactor that is closed to provide power to the ESP, and a charging resistor that allows a capacitor or local bus at the input of the drive to be charged before the charging contactor is closed.

### CROSS-REFERENCE TO RELATED APPLICATIONS

This application claims the benefit of U.S. Provisional Patent Application 62/108,384, filed Jan. 27, 2015 by Brian Haapanen, et al., which is incorporated by reference as if set forth herein in its entirety.

### BACKGROUND

The invention relates generally to electrical control systems, and more particularly to systems and methods for providing power to well equipment such as variable speed drives that are used to drive artificial lift systems (e.g., electric submersible pumps).

Artificial lift systems such as electric submersible pumps (ESP's) are commonly used to pump crude oil from wells that are drilled into geological formations. In a typical installation, electric power from a power grid or generator is input to an electric drive system. The electric drive system converts the input power to a form that is suitable to drive the ESP. The electric drive system may, for example, be a variable speed drive (VSD) which is designed to allow the output power waveform to be varied, thereby controlling the operating parameters (e.g., speed) of the ESP. The output power from the electric drive system is transmitted to the ESP over power cables that extend from the electric drive system which may include a step-up transformer and which is located at the surface of the well, to the ESP, which is located downhole in the well.

Conventionally, a VSD has three sections: a rectifier section; a DC bus section, and an inverter section. The rectifier section receives AC (alternating current) input power from an external source, such as a power grid or an AC generator and rectifies this AC input power to produce DC (direct current) power. The DC output of the rectifier section is provided to the DC bus section. The DC bus section may include one or more capacitor banks or other energy storage devices that buffer or store the energy received from the rectifier section. The inverter section is coupled to the DC bus section and converts the DC voltage on the bus to an AC output signal. This AC output signal may have various waveforms, but it is commonly a PWM (pulse width modulated) or six-step waveform.

As noted above, the generators that are employed in conventional oilfield applications typically produce AC output power that is then converted to a different form of AC power which is suitable to drive an ESP. In some cases, an AC power grid or one or more AC generators are used to supply AC power to one or more VSD's. In other cases, a DC generator is incorporated into the electric drive system itself, eliminating the need for the rectifier section of the drive. The DC output of the generator is coupled directly to the DC bus from which the inverter draws power. The resulting system, which generates its own power and produces a variable-speed output for an ESP, is sometimes referred to as a variable speed generator (VSG).

When it is desired to drive multiple ESP's that are installed in different wells, conventional VSD's or VSG's may be used. It is necessary, however, to have a separate unit (VSD or VSG) to drive each ESP. The VSD's can be coupled to a common AC power source, but for each ESP, the corresponding VSD must convert the received AC power to DC, and then generate a new AC output signal. If VSG's are used, it is not necessary to rectify AC input power, but each VSG must incorporate its own separate DC generator. It would be desirable to provide a means to drive multiple ESP's in multiple wells that is simpler than both conventional VSD's and VSG's. Additionally, it would be desirable to enable VSD's to take advantage of multiple, common sources of power.

### SUMMARY

Embodiments of the present invention resolve this problem by providing a system in which a one or more DC generators provide DC power to a common DC bus. Multiple drives are coupled through interface units to the common DC bus. Each of the drives has an inverter section which draws power through the corresponding interface unit from the common DC bus and consequently does not need to have a rectifier section. Each interface unit may, for example, include a charging resistor and a set of contactors. The charging resistor allows a capacitor at the input of the inverter section to be charged before the contactors are closed, to couple the inverter inputs to the common DC bus. When coupled to the common DC bus, the inverter section of each drive draws power from the bus, which is converted to an appropriate AC signal (e.g., a low voltage PWM signal) to drive the ESP. The AC output signal of the drive may be coupled by a step-up transformer to a power cable that extends downhole to the ESP in order to maintain isolation of the ESP and any gauge package that is connected to the ESP.

One embodiment comprises a system for lifting fluids out of wells, where the system includes one or more sources of DC power that are coupled to provide power to a common DC bus, and multiple ESP systems that are coupled to the common DC bus to draw power from the bus. Each ESP system is coupled to the common DC bus by an interface unit. An electric drive is coupled to the interface unit to receive DC power from the common DC bus. The electric drive uses the DC power from the common bus to generate output power suitable to run the ESP system's motor, which in turn drives the ESP system's pump. When the motor is run, the pump lifts fluids out of the well.

The common DC bus may receive power from multiple, different sources, that produce DC power from either AC or DC input power. The interface unit may include, for example, an input contactor, or switch, that is alternately opened and closed. When the contactor is open, DC power from the common DC bus is prevented from passing through the contactor to the electric drive. When the contactor is closed, DC power from the common DC bus is allowed to pass through the contactor to the electric drive, which then converts power to run the motor. The interface unit may also include a charging resistor or other charging circuitry that is coupled in parallel to an additional charging contactor between the common DC bus and the electric drive. The charging resistor allows a small amount of current to flow from the common bus to the electric drive, or to a local DC bus coupled between the drive and the interface unit, to allow it to be charged while the contactor is open, thereby preventing a sudden rush of higher than rated current when the charging contactor is closed. The electric drive may be a variable speed drive that is capable of causing the motor to run at different speeds. An isolation transformer may be coupled between the electric drive and the motor.

An alternative embodiment may comprise a method for lifting fluids out of wells. In this method, a common DC bus is provided. Multiple ESP systems are coupled to the common DC bus. Each ESP system includes an interface unit coupled to the common DC bus, an electric drive that receives DC power from the common DC bus via the interface unit, a motor coupled to receive the output power generated by the electric drive, and a pump that is driven by the motor to lift fluid out of a well in which the ESP system is installed. The common DC bus is charged by one or more power sources that may produce DC output power from various different types of input power. The interface unit of each ESP system is controlled to selectively provide power from the common DC bus to the motors of the respective ESP systems, thereby driving the pumps of the ESP systems to lift fluids out of the respective wells. Each interface unit may be controlled by selectively opening and closing a contactor in the interface unit. A local DC bus may be provided between the interface unit and the electric drive, and a charging resistor or other circuitry may be provided in the interface unit to charge the local DC bus from the common DC bus. The electric drive may then draw DC power from the local DC bus. An isolation transformer may be provided in each ESP system between the electric drive and the motor of the ESP system.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating a conventional pump system.

FIG. 2 is a functional block diagram illustrating the structure of a conventional pump system that uses an AC-driven VSD.

FIG. 3 is a functional block diagram illustrating the structure of a prior art pump system that uses a VSG instead of a conventional AC-driven VSD.

FIG. 4 is a functional block diagram illustrating the structure of a pump system that uses a common DC bus to power multiple ESP's in accordance with an exemplary embodiment of the invention.

FIG. 5 is a functional block diagram illustrating the coupling of multiple power sources of different types to a common DC bus in accordance with an alternative embodiment of the invention.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for providing AC power to multiple pieces of downhole equipment such as ESP's. In one embodiment, the system has a common DC bus that receives power from one or more DC generators. One or more capacitors or other types of energy storage devices may be coupled to the common DC bus to buffer or store the energy received from the one or more DC generators. Multiple ESP's may be coupled to the common bus. Each of the ESP's is driven by a separate VSD that does not have a rectifier. The VSD is configured to receive DC power from the common DC bus through a corresponding interface that includes a charging resistor and one or more contactors that can selectively connect the VSD to the common DC bus. An additional capacitor bank can be placed at the input of the drive for additional energy storage near the inverter of the VSD. A step-up transformer or isolation transformer may be coupled between the VSD and the corresponding ESP. The step-up transformer electrically isolates the drive from the entire ESP system, which may include one or more gauges.

Embodiments of the present invention may provide a number of advantages over the prior art. For example, because DC power is supplied to a common DC bus, and DC power from the common bus is provided to the inverter sections of the VSD's, there is no need for the VSD's to include rectifier sections to convert the AC power to DC power (as in a conventional VSD). The elimination of VSD components that rectify supplied AC power reduces the complexity and cost of the system. In comparison to VSG's, the use of a common DC bus eliminates the need to provide a separate generator for each VSG, as well as the components necessary to rectify the AC output of the generator. This may also allow the VSD's to utilize multiple sources of DC power, including various sources that may be unconventional in the industry (e.g., multiple micro-turbines that may each provide power to the common DC bus). Additionally, if any of the multiple power sources are interrupted, the use of the common DC bus that receives power from these sources increases the ride-through capability of the system (the ability of the ESP's to continue to operate through the power interruptions). By transmitting AC power of each VSD to the respective ESP through a step-up or isolation transformer, the system maintains electrical isolation of the ESP's and associated gauge packages.

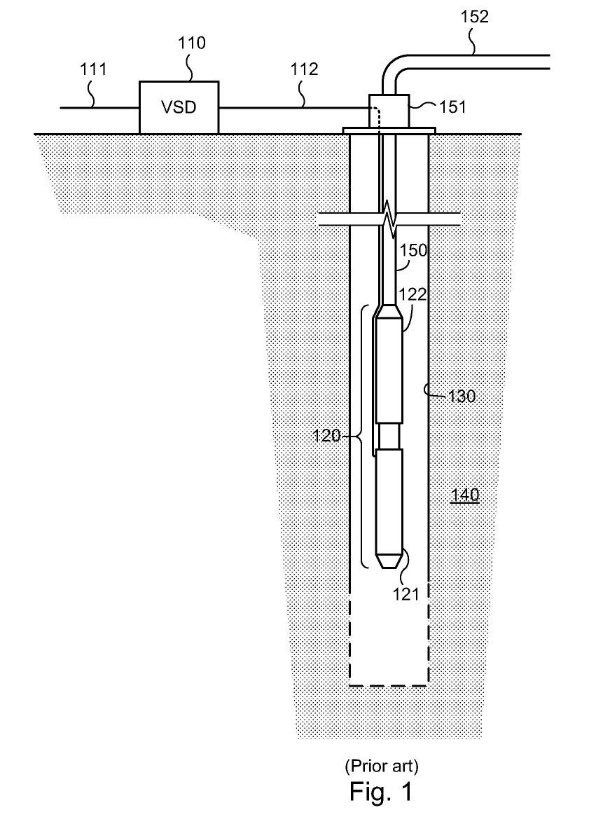

Before describing exemplary embodiments of the invention in detail, it may be helpful to describe conventional systems. Referring to FIG. 1, a diagram illustrating a conventional pump system is shown. A wellbore 130 is drilled into an oil-bearing geological structure 140, and is cased. The casing within wellbore 130 is perforated at the lower end of the well to allow oil to flow from the formation into the well. ESP 120 is coupled to the end of tubing string 150, and the pump and tubing string are lowered into the wellbore to position the pump in producing portion of the well.

A VSD 110 which is positioned at the surface is coupled to ESP 120 by power cable 112, which runs down the wellbore along tubing string 150. Power cable 112 is coupled to an electric motor section 121 of ESP 120. Motor section 121 drives pump section 122 to pump oil through tubing string 150 to well head 151. The oil then flows out through production flow line 152 and into storage tanks (not shown in the figure.)

In this embodiment, motor section 121 is an induction motor which is driven by variable speed drive 110. Variable speed drive 110 receives AC (alternating current) input power from an external source such as a power grid or AC generator (not shown in the figure) via input line 111. Drive 110 rectifies the AC input power and then produces output power that is suitable to drive motor section 121 of pump 120. The voltage and frequency of the drive output signal can be varied to adjust the speed of the pump motor.

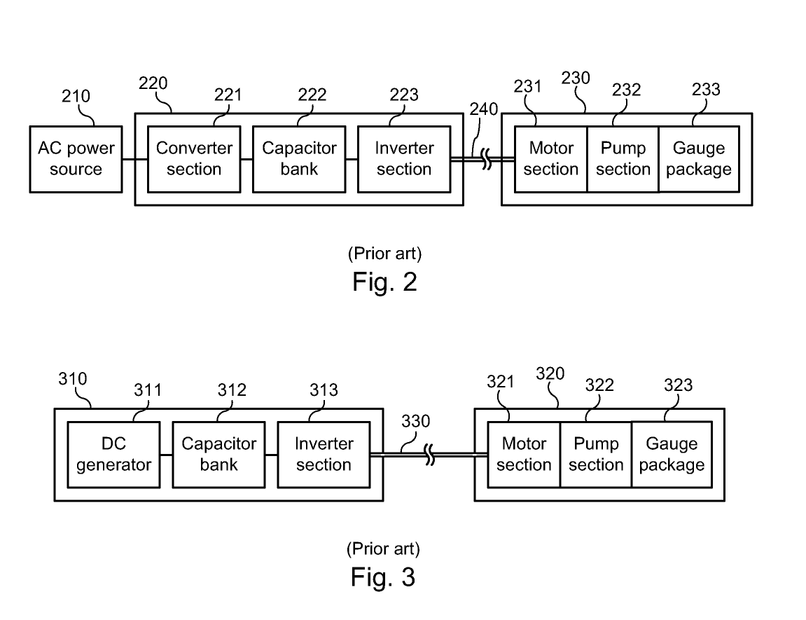

Referring to FIG. 2, a functional block diagram illustrating the structure of a conventional pump system that uses a VSD is shown. The system includes an AC power source 210, a VSD 220 and an ESP 230. AC power source 210 may be, for example, a three-phase, 50-60 Hz, 480 V power source. The three-phase power from source 210 is provided to the converter section 221 of VSD 220. Converter section 221 converts the AC power to DC, and the output of the converter section charges a capacitor bank 222. Capacitor bank 222 provides DC power to an inverter section 223 of the VSD. Inverter section 223 draws energy from the capacitor bank and produces an output voltage which is used to drive ESP 230. The output voltage of variable speed drive 220 is transmitted to ESP 230 via cable 240 and is used to power the motor section 231 of the ESP. Motor section 231 then drives pump section 232 to pump fluid out of the well. Power provided to motor section 231 may also be provided through the motor to a gauge package 233.

Referring to FIG. 3, a functional block diagram illustrating the structure of a prior art pump system that uses a VSG instead of a conventional AC-driven VSD. In this embodiment, system 300 includes a VSG 310, which provides AC output power to drive ESP 320. This system does not receive power from an external source, but includes a DC generator 311 that is a subsystem of VSG 310. DC generator 311 generates DC power and provides this power to a capacitor bank 312. DC power from capacitor bank 312 is drawn by inverter section 313, which converts the DC power from the capacitor bank to AC output power. The AC output power is suitable to drive ESP 320. The output voltage of VSG 310 is transmitted to ESP 320 via cable 330 and is used to power the motor section 321 of the ESP. Motor section 321 then drives pump section 322, which pumps fluid out of the well. A gauge package 323 is coupled to the motor section 321 to receive power from the motor. Gauge package 323 may also transmit and receive data through motor section 321 and power cable 330.

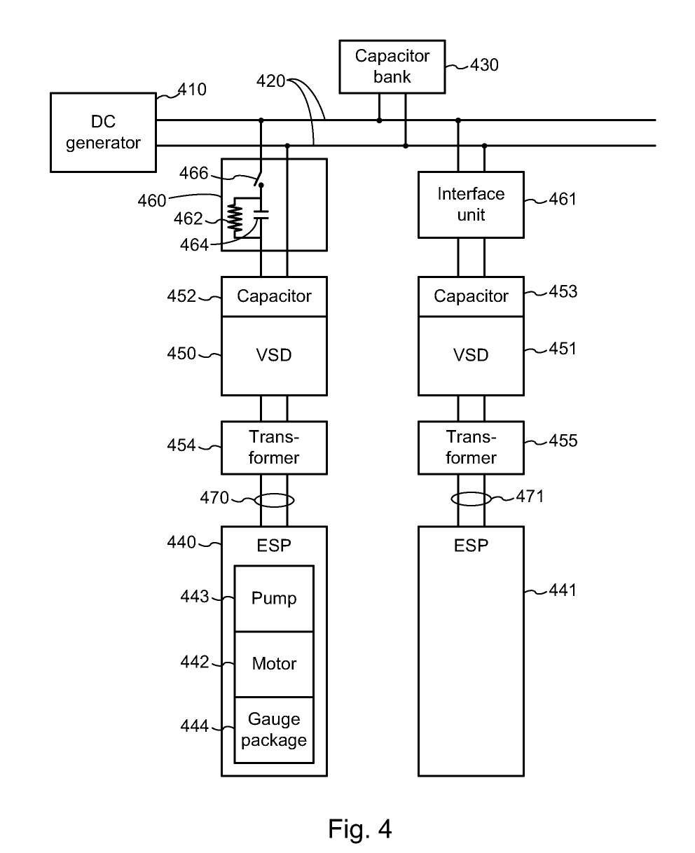

Referring to FIG. 4, a functional block diagram illustrating the structure of a pump system in accordance with an exemplary embodiment of the invention is shown. In this embodiment, a DC generator 410 produces DC power that is output to a DC bus 420. Additional DC generators may be coupled to DC bus 420 as needed to provide power to the ESP systems. A capacitor bank 430 or other type of energy storage device may be coupled to DC bus 420, although this may not be necessary if a capacitor is provided at the inputs of each ESP's VSD.

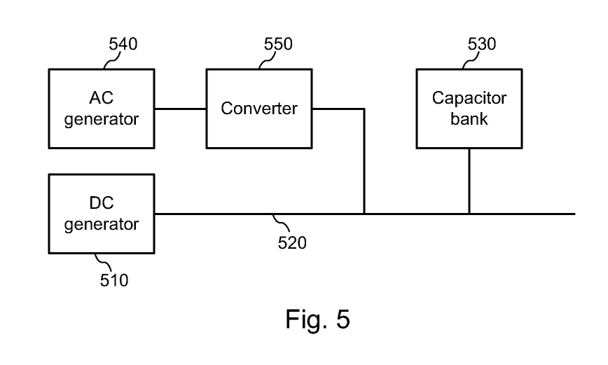

Although the embodiment of FIG. 4 uses a DC generator 410 to provide power to common DC bus 420, alternative embodiments may utilize multiple power sources, and may utilize power sources of different types. For example, FIG. 5 illustrates an alternative configuration for the power sources. In this figure, a DC generator 510 is coupled to DC bus 520 and capacitor bank 530 in the same manner as shown in FIG. 4. The configuration of FIG. 5, however, also has an AC generator 540 that is coupled to bus 520 through a converter 550 to provide DC power to the common DC bus.

Referring again to FIG. 4, one or more ESP's (e.g., 440, 441) are driven using the power from DC bus 420. Each of the ESP's is driven by a corresponding VSD (e.g., 450, 451) that is coupled to DC bus 420 through an interface unit (e.g., 460,461). DC power is drawn from DC bus 420 by the VSD's and is converted by the VSD's to AC power, which is then transmitted to the motors of the ESP's. The VSD's control the generated AC output power to control the speeds of the respective ESP's.

In the embodiment of FIG. 4, each of the interface units 460, 461 has an input contactor (e.g., 466) and a charging contactor (e.g., 464) that can be opened or closed to selectively allow current to flow from DC bus 420 to the corresponding VSD. Input contactor 466 can be closed to connect the VSD to the DC bus, or it can be opened to completely disconnect the VSD from the DC bus. When input contactor 466 is closed and charging contactor 464 is open, a small amount of current is allowed to flow through charging resistor 462 to the VSD. When input contactor 466 and charging contactor 464 are both closed, current flows from the DC bus through the contactors to the VSD.

When the charging contactor is open (and the input contactor is closed), the current through the resistor charges a capacitor (e.g., 452, 453) at the input of the VSD to the potential of DC bus 420. By charging the VSD capacitor to the DC bus potential, the system prevents sudden, potentially damaging inrushes of current from the DC bus to the VSD when the charging contactor is closed. After the charging contactor and the input contactor are both closed, the VSD draws energy from the bus and provides power to the ESP.

Because each VSD is connected to the common DC bus and receives DC power from the bus, it is not necessary for the VSD to incorporate a rectifier section. The VSD simply draws the already-rectified DC power from the bus. The DC power from the bus is used to charge a local capacitor bank of the VSD. If it is necessary to store DC energy at the bus level, this can be accomplished by coupling a capacitor bank or other energy storage device (e.g., a battery) to the common DC bus.

As noted above, the use of a DC generator and a common DC bus eliminates the need for the VSD's to include a rectifier section. The VSD's only have a local capacitor bank and an inverter section that converts the DC power from the common DC bus to an AC output waveform that is appropriate for the corresponding ESP. This waveform may be a PWM waveform, or any other waveform that is suitable to drive the ESP. Although not shown in FIG. 4, filters or other means to process the AC waveform produced by the VSD may be coupled to the output of the VSD.

In the embodiment of FIG. 4, the AC output of the VSD is coupled to the power cable (e.g., 470, 471) by a transformer (e.g., 454, 455). The VSD may produce a low-voltage output that is converted by a step-up transformer to a high voltage that limits the voltage across long segments of cable and allows smaller diameter conductors to be used. Alternatively, the transformer may simply provide electrical isolation of the ESP (which may be necessitated by the use of a floating ground in the ESP), and may not alter the voltage of the VSD's output waveform. The power cable carries the VSD output waveform from the transformer to the motor (e.g., 442) of the ESP. The VSD output waveform drives the motor, which in turn drives the pump (e.g., 443). The ESP may include a gauge package (e.g., 444) to monitor one or more conditions in the well. The gauge package may be coupled to receive power from the motor, and to communicate with surface equipment through the motor.

As noted above, the embodiment of FIG. 4 is exemplary of the invention, rather than limiting. Alternative embodiments may have one or more features that vary from the described exemplary embodiment. These variations may include, for example, the use of multiple DC generators (or AC generators and converters) to provide power to the common DC bus, the use of one or multiple ESP's, the use of one, none, or multiple DC energy storage devices coupled to the common bus, the use of a charging resistor (e.g., 462, 463) that bypasses the contactors between the common DC bus and the VSD(s), the use of capacitors (e.g., 452, 453) at the inputs of the VSD(s), and the use of step-up or isolation transformers at the output of the VSD(s). Still other variations may be apparent to a person of ordinary skill in the art.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A system for lifting fluids out of wells comprising:
one or more sources of DC power;
a common DC bus coupled to receive DC power from the one or more sources of DC power; and
a plurality of electric submersible pump (ESP) systems coupled to the common DC bus, wherein each ESP system includes:
an interface unit coupled to the common DC bus,
an electric drive coupled to the interface unit, wherein the electric drive receives DC power from the common DC bus via the interface unit and generates output power,
a motor coupled to receive the output power generated by the electric drive, and
a pump coupled to the motor, wherein the motor drives the pump to lift fluid out of a well in which the ESP system is installed.

2. The system of claim 1, wherein the one or more sources of DC power include at least two different types of DC power sources.

3. The system of claim 2, wherein the one or more sources of DC power include at least one source that generates DC power from received AC power and at least one source that generates DC power from received DC power.

4. The system of claim 1, wherein the interface unit comprises a contactor that is alternately opened and closed, wherein when the contactor is open, DC power from the common DC bus is prevented from passing through the contactor to the electric drive, and wherein when the contactor is closed, DC power from the common DC bus is allowed to pass through the contactor to the electric drive.

5. The system of claim 1, wherein each ESP system includes a local DC bus which is coupled between the interface unit and the electric drive, wherein the local DC bus is charged by the common DC bus, and wherein the electric drive draws DC power from the local DC bus.

6. The system of claim 1, wherein each ESP system includes an isolation transformer coupled between the electric drive and the motor.

7. The system of claim 1, wherein the electric drive comprises a variable speed drive.

8. A method for lifting fluids out of wells, the method comprising:
providing a common DC bus;
coupling a plurality of electric submersible pump (ESP) systems to the common DC bus, wherein each ESP system includes:
an interface unit coupled to the common DC bus,
an electric drive coupled to the interface unit, wherein the electric drive receives DC power from the common DC bus via the interface unit and generates output power,
a motor coupled to receive the output power generated by the electric drive, and
a pump coupled to the motor, wherein the motor drives the pump to lift fluid out of a well in which the ESP system is installed;
charging the common DC bus; and
controlling the interface unit of each ESP system to selectively provide power from the common DC bus to the motor of the ESP system, thereby driving the pump of the ESP system and causing the pump to lift fluids out of the well in which the ESP system is installed.

9. The method of claim 8, wherein charging the common DC bus comprises providing DC power to the common DC bus from at least two different types of DC power sources.

10. The method of claim 9, wherein the one or more sources of DC power include at least one source that generates DC power from received AC power and at least one source that generates DC power from received DC power.

11. The method of claim 8, wherein the interface unit of each ESP system comprises a contactor, wherein controlling the interface unit of each ESP system to selectively provide power from the common DC bus to the motor of the ESP system comprises alternately opening and closing the contactor, wherein when the contactor is open, DC power from the common DC bus is prevented from passing through the contactor to the electric drive, and wherein when the contactor is closed, DC power from the common DC bus is allowed to pass through the contactor to the electric drive.

12. The method of claim 8, wherein each ESP system includes a local DC bus which is coupled between the interface unit and the electric drive, wherein the method includes charging the local DC bus with current that flows from the common DC bus, and the electric drive drawing DC power from the local DC bus.

13. The method of claim 8, further comprising providing an isolation transformer in each ESP system, wherein the isolation transformer is coupled between the electric drive and the motor of the ESP system.

14. The method of claim 8, wherein the electric drive comprises a variable speed drive, and wherein the variable speed drive provides output that is varied to cause the motor to run at different speeds.
